(19) United States
(12) Patent Application Publication
(10) Pub. No.: US 2017/0324864 A1
(43) Pub. Date: Nov. 9, 2017

(54) INTERACTIVE CALL CONTEXT IDENTIFICATION

(71) Applicant: International Business Machines Corporation, Armonk, NY (US)

(72) Inventors: Gregory J. Boss, Saginaw, MI (US); Andrew R. Jones, Round Rock, TX (US); Charles S. Lingafelt, Durham, NC (US); Kevin C. McConnell, Austin, TX (US); John E. Moore, JR., Brownsburg, IN (US)

(21) Appl. No.: 15/661,336

(22) Filed: Jul. 27, 2017

Related U.S. Application Data
(63) Continuation of application No. 15/140,520, filed on Apr. 28, 2016.

(51) Int. Cl. H04M 3/436

(52) U.S. Cl. CPC H04M 3/4365

(57) ABSTRACT

An indication of a call from a first device to a second device is received. The indication includes making the call by a first user using the first device to a second user using the second device. User preferences of the second user receiving the call using the second device is determined. A mode based on the user preferences of the second user is determined. Responsive to determining the mode, a question to transmit to the first device is determined. The question is transmitted to the first device. A response to the question from the first device is received. Responsive to receiving a response to the question from the first device, an action the second device will take is determined based on the received response from the first device.

### BACKGROUND OF THE INVENTION

The present invention relates generally to the field of telecommunication, and more particularly to identifying the context of initiated telecommunication.

Telecommunication is the transmission, emission, or reception of signs, signals, writings, images, and/or sounds of any nature by wire, radio, optical, or any other electromagnetic system. Channels are used to transmit information (e.g., electrical signals) over a physical medium (e.g., signal cables or air). Examples of telecommunication technologies are telephones, radios, microwave transmission, fiber optics, and satellites. Examples of telecommunication networks include, but are not limited to, a public switched telephone network (PSTN) (e.g., an analog landline network of telephones, a cellular network for mobile devices, or communication satellites) and the Internet.

Voice over Internet Protocol (VoIP) is a technology that converts analog audio signals into digital data that can be transmitted over the Internet (i.e., a technology that enables a caller to make voice calls using a broadband Internet connection instead of a telephone network). If a caller using VoIP calls a caller using an analog network, the VoIP digital signal is converted to an analog signal before it reaches the caller using the analog network. VoIP can be used on a wired or wireless internet connection or via an analog telephone adapter.

### SUMMARY

Embodiments of the present invention include a method, computer program product, and system for providing additional context of a call from a caller. In one embodiment, an indication of a call from a first device to a second device is received. The indication includes making the call by a first user using the first device to a second user using the second device. User preferences of the second user receiving the call using the second device is determined. A mode based on the user preferences of the second user is determined. Responsive to determining the mode, a question to transmit to the first device is determined. The question is transmitted to the first device. A response to the question from the first device is received. Responsive to receiving a response to the question from the first device, an action the second device will take is determined based on the received response from the first device.

### BRIEF DESCRIPTION OF THE DRAWINGS

FIG. 1 is a functional block diagram illustrating a computing environment, in accordance with an embodiment of the present invention;

FIG. 2 is a flowchart of operational steps of a call response program for providing additional context of a call from a caller; and

FIG. 3 depicts a block diagram of components of the computing device of FIG. 1, in accordance with an embodiment of the present invention.

### DETAILED DESCRIPTION

Embodiments of the present invention recognize that it is not always convenient for the receiver of a call to answer the call. However, the receiver of a call does not necessarily know the context of a call. In some instances, when it would not be appropriate to answer a non-urgent call, the receiver of the call might want to answer the call if the call is urgent. Advantages of some embodiments of the invention include: (i) a receiver of a phone call gaining context of a phone call before answering the call, (ii) the receiver of a phone being able to communicate with the caller of a phone call prior to answering the call, and (iii) the ability for a receiver of a phone call to answer phone calls that are important, while ignoring phone calls the receiver is not interested in answering at the moment.

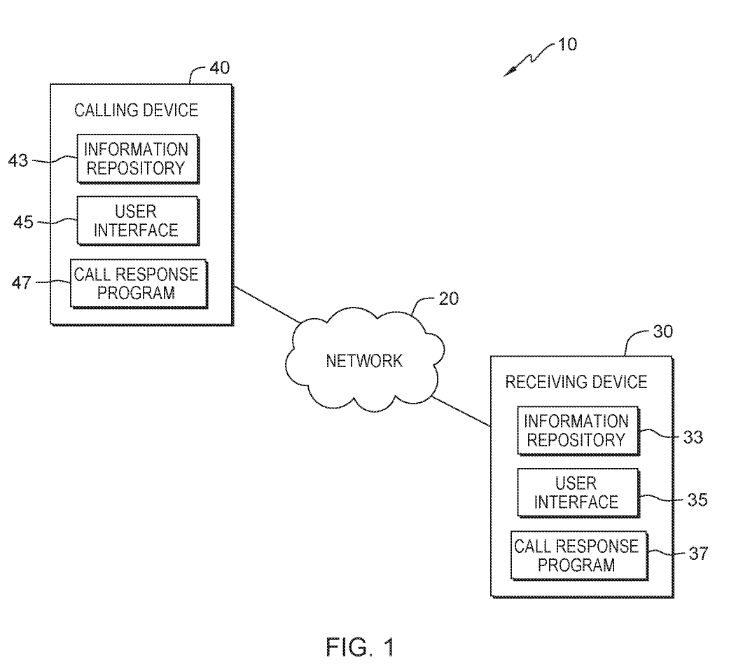

FIG. 1 depicts a diagram of computing environment 10 in accordance with one embodiment of the present invention. FIG. 1 provides an illustration of one embodiment and does not imply any limitations with regard to the environments in which different embodiments may be implemented.

In the depicted embodiment, computing environment 10 includes receiving device 30 and calling device 40 interconnected over network 20. Network 20 may be a local area network (LAN), a wide area network (WAN) such as the Internet, a public switched telephone network (PSTN), any combination thereof, or any combination of connections and protocols that will support communications between receiving device 30 and calling device 40 in accordance with embodiments of the present invention. Network 20 may include wired, wireless, fiber optic, satellite, cellular, or analog connections. Computing environment 10 may include additional computing devices, servers, or other devices not shown.

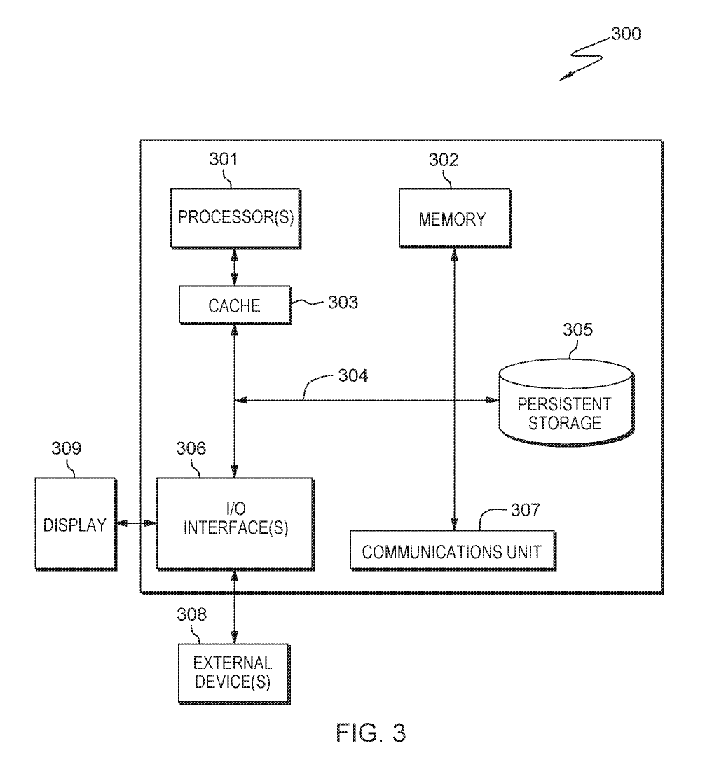

Receiving device 30 may be a desktop computer, laptop computer, tablet computer, personal digital assistant (PDA), or smart phone. In general, receiving device 30 may be any electronic device or computing system capable of executing computer readable program instructions, and communicating with calling device 40 over network 20. In an embodiment, receiving device 30 contains information repository 33, user interface (UI) 35, and call response program 37. Receiving device 30 may include components as depicted and described in further detail with respect to FIG. 3.

In an embodiment, information repository 33 is a repository that may be written to and/or read by call response program 37. In an embodiment, information repository 33 stores data such as, but not limited to, user preferences and a list of contacts. The user preferences are preferences that are predetermined by the user of receiving device 30. The user preferences inform call response program 37 of the actions call response program 37 should take when an incoming call is received from a user of a calling device. User preferences may include, but are not limited to, whether manual mode should be enabled, whether automatic mode should be enabled, a list of predetermined questions, and instructions on the action(s) call response program 37 should take in particular instances (e.g., particular users, when the call is received at a certain time or location, etc.), from whom to accept contextual call information, when to accept contextual call information, and what action should occur based on the importance, weight, or urgency of the contextual call information. In some embodiments, information repository 33 resides on receiving device 30. In other embodiments, information repository 33 may reside on another computing device, provided that information repository 33 is accessible to call response program 37.

Information repository 33 may be implemented using any volatile or non-volatile storage media for storing information, as known in the art. For example, information repository 33 may be implemented with a tape library, optical library, one or more independent hard disk drives, or multiple hard disk drives in a redundant array of independent disks (RAID). Similarly, information repository 33 may be implemented with any suitable storage architecture known in the art, such as a relational database, an object-oriented database, or one or more tables.

UI 35 operates on receiving device 30 to visualize content, such as menus and icons, and to allow a user to interact with an application accessible to receiving device 30. In an embodiment, UI 35 comprises an interface to call response program 37. UI 35 may display data received from call response program 37 and send input received from a user of receiving device 30 to call response program 37. In other embodiments, UI 35 may comprise one or more interfaces such as, an operating system interface and/or application interfaces. In example embodiments, a user of receiving device 30, via UI 35, communicates with call response program 37.

A user interface, as shown by UI 35, is a program that provides an interface between a user and an application. A user interface refers to the information (such as graphic, text, and sound) a program presents to a user and the control sequences the user employs to control the program. There are many types of user interfaces. In an embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. The actions in GUIs are often performed through direct manipulation of the graphics elements.

In an embodiment, call response program 37 operates to determine how to respond to incoming calls received by receiving device 30 from the user of calling device 40. In an embodiment, call response program 37 prompts the user of receiving device 30 to preselect user preferences. The user preferences indicate to call response program 37 the action(s) call response program 37 should take based on factors such as, but not limited to, the caller, the time the call is received, the location of the user of receiving device 30 when the call is received, etc. In an embodiment, call response program 37 responds to incoming calls according to the predetermined user preferences of the user of receiving device 30. For example, call response program 37 determines if manual or automatic mode (explained later) are enabled and determines a question to send to the user of calling device 40 if manual mode or automatic mode is enabled, based on the user preferences of the user of receiving device 30. In an embodiment, the determined question is a query directed at the user of calling device 40. For example, “Is this an emergency?” In another embodiment, the determined question is a query that is directed to calling device 40 with no human interaction. For example, “What is the current heart rate of the caller?” In an embodiment, call response program 37 receives a response from the user of calling device 40. In an embodiment, call response program 37 responds based on the response of the user from calling device 40.

Calling device 40 may be a desktop computer, laptop computer, tablet computer, personal digital assistant (PDA), or smart phone. In general, calling device 40 may be any electronic device or computing system capable of executing computer readable program instructions, and communicating with receiving device 30 over network 20. In an embodiment, calling device 40 contains information repository 43, UI 45, and call response program 47. Calling device 40 may include components as depicted and described in further detail with respect to FIG. 3.

In an embodiment, the user preferences of call response program 47 are linked to calling device 40 (i.e., preferences are specific to the calling device the preferences are stored on). For example, there are multiple users of calling device A. The user preferences for calling device A are the same, regardless of the user using calling device A. In another embodiment, user preferences of call response program 47 are linked to a particular user. For example, there are multiple users of laptop B. Each user has a unique ID and password. Each unique ID has an account with user preferences that are specific to the associated account of the unique ID. In an embodiment, the account associated with a unique ID is accessible from any calling device.

In an embodiment, information repository 43 is a repository that may be written to and/or read by call response program 47. In an embodiment, information repository 43 stores data such as, but not limited to, user preferences. The user preferences include when to send contextual call information and to whom to send contextual call information. In some embodiments, information repository 43 resides on calling device 40. In other embodiments, information repository 43 may reside on another server, or another computing device, provided that information repository 43 is accessible to call response program 47.

Information repository 43 may be implemented using any volatile or non-volatile storage media for storing information, as known in the art. For example, information repository 43 may be implemented with a tape library, optical library, one or more independent hard disk drives, or multiple hard disk drives in a redundant array of independent disks (RAID). Similarly, information repository 43 may be implemented with any suitable storage architecture known in the art, such as a relational database, an object-oriented database, or one or more tables.

UI 45 operates on calling device 40 to visualize content, such as menus and icons, and to allow a user to interact with an application accessible to calling device 40. In an embodiment, UI 45 comprises an interface to call response program 47. UI 45 may display data received from call response program 47 and send input received from a user of calling device 40 to call response program 47. In other embodiments, UI 45 may comprise one or more interfaces such as, an operating system interface and/or application interfaces. In example embodiments, a user (through input via UI 45) of calling device 40 communicates with call response program 47.

A user interface, as shown by UI 45, is a program that provides an interface between a user and an application. A user interface refers to the information (such as graphic, text, and sound) a program presents to a user and the control sequences the user employs to control the program. There are many types of user interfaces. In an embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. The actions in GUIs are often performed through direct manipulation of the graphics elements. For example, client application may be a web browser, a database program, etc.

In an embodiment, call response program 47 operates to communicate with call response program 37. In an embodiment, when call response program 47 is located on and/or is in communication with calling device 40, the user of calling device 40 may respond to call response program 37 via call response program 47. The response may be in the form of a textual or audio response. In an embodiment, the user of calling device 40 can pre-select user preferences. User preferences include, but are not limited to, enabling call response program 47 to automatically send a response to call response program 37 (i.e., send an automatic response without user interaction at that moment), and selecting to whom to send contextual call information, selecting when to send contextual call information. For example, Bob pre-selects a user preference that enables call response program 47 to send the GPS coordinates of calling device 40 to call response program 37, if call response program 37 sends the question, “Where are you?” to call response program 47. In an embodiment, contextual information includes, but is not limited to, GPS coordinates of calling device 40 and any other contextual information gathered by call response program 47 (e.g., deployment of airbags in the car where calling device 40 is located). In an embodiment, call response program 47 is optional on, or in communication with, calling device 40 (i.e., call response program 47 is not required for call response program 37 to function). In an embodiment, call response program 47 and call response program 37 have the similar function and any can perform any or all steps of the workflow or in conjunction with one another. In an embodiment, call response program 47 is substantially similar to call response program 37.

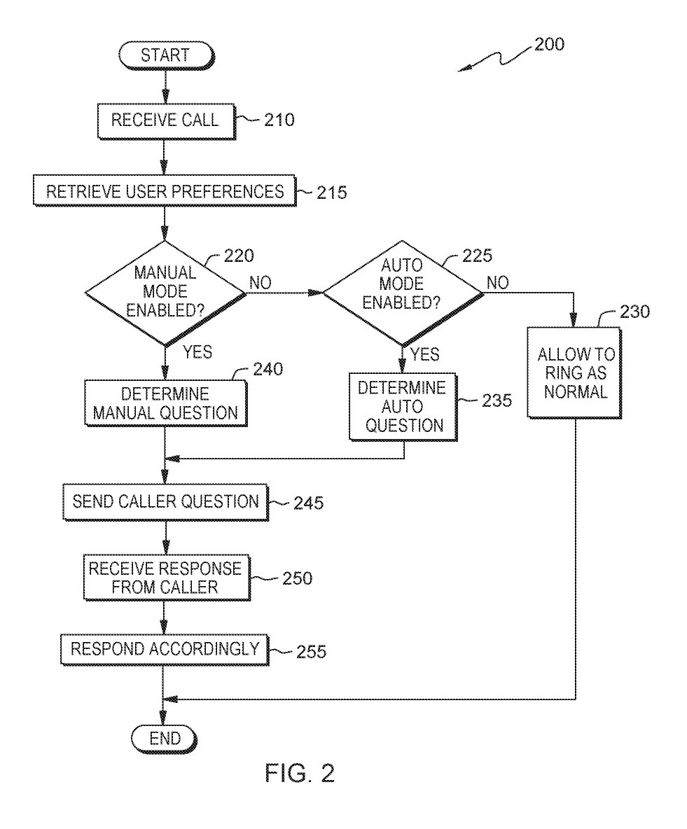

FIG. 2 depicts a flowchart of operational steps 200 of call response program 37 executing within the computing environment of FIG. 1, in accordance with an embodiment of the present invention. Call response program 37 operates to receive the context of a phone call from the user of calling device 40 so the user of receiving device 30 can decide if the user of receiving device 30 wants to answer the phone call. In an embodiment, the steps of the workflow are performed by call response program 37. Alternatively, steps of the workflow can be performed by any other program while working with call response program 37. A user can invoke operational steps 200 by calling the user of receiving device 30.

In step 210, call response program 37 receives an indication of a call. In an embodiment, call response program 37 receives an indication that receiving device 30 is receiving a call from calling device 40. In an embodiment, call response program 37 receives the indication in a form that is standard for the particular form of communication used to place the call (e.g., VoIP or analog telecommunication). In an embodiment, a call is placed via an analog telecommunications network. In another embodiment, a call is placed using VoIP. In other embodiments, a call is placed by any telecommunication protocol that connects two or more callers and/or receivers.

In step 215, call response program 37 retrieves the user preferences. In an embodiment, call response program 37 retrieves the user preferences of the user of receiving device 30. The user preferences are predetermined by the user of receiving device 30 and are stored to information repository 33 via UI 35. In an embodiment, call response program 37 retrieves the user preferences of the user of receiving device 30 to determine how to respond to the incoming call from the user of calling device 40. For example, call response program 37 retrieves the user preferences of Bob that indicates that how call response program 37 should respond to incoming calls in the afternoon.

In decision block 220, call response program 37 determines if manual mode is enabled on receiving device 30. In an embodiment, call response program 37 determines if manual mode is enabled on receiving device 30 by analyzing the user preferences that were predetermined by the user of receiving device 30. For example, after call response program 37 retrieves the user preferences of receiving device 30, call response program 37 searches the user preferences to determine if the user predetermined manual mode. In an embodiment, based on the predetermined user preferences, manual mode is enabled for particular callers (e.g., a subset of contacts in the address book of the user of receiving device 30). In another embodiment, based on predetermined user preferences, manual mode is enabled for all callers (i.e., any caller from any calling device that calls the user of receiving device 30). In an embodiment, based on predetermined user preferences, manual mode is enabled based on a preset time frame (e.g., on Mondays from noon to 4 PM).

If call response program 37 determines that manual mode is not enabled (decision block 220, no branch), call response program 37 determines if automatic mode is enabled (decision block 225). In an embodiment, call response program 37 determines if automatic mode is enabled on the receiving device 30 based on the user preferences predetermined by the user of receiving device 30. For example, within the user preferences, call response program 37 asks the user whether automatic mode should be enabled. Call response program 37 receives an indication from the user of receiving device 30 when the user of receiving device 30 selects “yes” or “no” in response. In an embodiment, when automatic mode is enabled on receiving device 30, call response program 37 automatically sends the user of calling device 40 a question (e.g., call response program 37 sends the user of calling device a question without prompting the user of receiving device 30 to select a question to send to the user of calling device 40). In an embodiment, call response program 37 retrieves user preferences to enable automatic mode for particular callers (e.g., a subset of contacts in the address book of the user of receiving device 30). In another embodiment, call response program 37 retrieves user preferences to enable automatic mode for all callers (i.e. any caller from any calling device that calls the user of receiving device 30). In an embodiment, call response program 37 retrieves user preferences to enable automatic mode based on a preset time frame (e.g., weekdays from 9 AM to 5 PM).

If call response program 37 determines that automatic mode is not enabled (decision block 225, no branch), call response program 37 allows the phone to ring as normal (step 230). In an embodiment, call response program 37 allows receiving device to ring as normal if automatic mode is not enabled. Processing ends when the call is answered, when the user of calling device 40 hangs up the phone, when the voicemail of receiving device 30 picks up the received call, or when the call ends without being answered.

If call response program 37 determines that automatic mode is enabled (decision block 225, yes branch), call response program 37 determines a question to send to the user of calling device 40 (step 235). In an embodiment, call response program 37 determines a question to send to the user of calling device 40 based on the user preferences predetermined by the user of receiving device 30. In an embodiment, call response program 37 sends a question based on the user that is calling the receiving device. In another embodiment, call response program 37 sends the same question to any user of any calling device. In an embodiment, call response program 37 automatically sends a particular question during a specified timeframe predetermined by the user of receiving device 30. In another embodiment, call response program 37 automatically sends a particular question anytime automatic mode is enabled. For example, the user of receiving device 30 predetermined that call response program 37 should send the question, “Is this urgent?” to the child of the user of receiving device 30 when the child of the user of receiving device 30 calls the user of receiving device 30 from calling device 40 on Saturdays from noon-4 PM. In another example, the user of receiving device 30 predetermined that call response program 37 should send the question, “Is this work related?” when call response program 37 receives an indication of a call on weekdays from 9 AM to 5 PM from a specific user.

If call response program 37 determines that manual mode is enabled (decision block 220, yes branch), call response program 37 prompts the user of receiving device 30 to manually determine a question (step 240). In an embodiment, when manual mode is enabled on receiving device 30, call response program 37 prompts the user of receiving device 30 to select a question from a predetermined set of questions to send to the user of calling device 40. In an embodiment, call response program 37 prompts the user of receiving device 30 to select a question that call response program 37 should send to the user of calling device 40. In an embodiment, call response program 37 retrieves a list of predetermined questions and prompts the user of receiving device 30 to select which question call response program 37 should send to the user of calling device 40. For example, call response program 37 retrieves a list of three predetermined questions. The questions are “Is this call urgent?”, “Are you on your way?”, and “How much longer until you arrive?” The questions are displayed on the screen of receiving device 30. The user of receiving device, via UI 35, manually selects the question “Is this call urgent?” as the question call response program 37 should send to the user of calling device 40. In another embodiment, call response program 37 prompts the user of receiving device 30 to type or speak a question that should be sent to the user of calling device 40. For example, call response program 37 prompts the user to type or speak a question. The user of receiving device 30 says, “How much longer until you arrive?” Call response program 37 sends the user of calling device the question, “How much longer until you arrive?” in the form of an audible question that is audible to the user of calling device 40.

In step 245, call response program 37 sends the user of calling device 40 the question. In an embodiment, call response program 37 sends the user of calling device 40 the determined question. In an embodiment, call response program 37 sends the determined question to the user of calling device 40 in the form of a text message. In another embodiment, call response program 37 sends the determined question to the user of calling device 40 in the form of an audible question.

In step 250, call response program 37 receives the response from the user of calling device 40 (from step 245). In an embodiment, call response program 37 receives the response of the user of calling device 40 when the user of calling device 40 responds by pressing a number on the keypad of calling device 40 (i.e., the message is received in the form of a 1, 2, 3, or 4 dual-tone multi-frequency signaling, which is more commonly known as touch-tone). In another embodiment, call response program 37 receives a response from the user of calling device 40 when the user of calling device 40 responds by sending a response in the form of a text. For example, call response program 37 receives a text message response from the user of calling device 40. In an embodiment, the received text is in the form of a text message (i.e., an in a text message sent through a cellular carrier or a third-party). In another embodiment, when the user of calling device 40 has call response program 47 installed on calling device 40, call response program 37 receives the response from the user of calling device 40, via call response program 47, in the form of a text or audible message sent to call response program 37. In an embodiment, call response program 37 receives the response from the user of calling device 40 in the form of an audible response that is sent via an analog telecommunication network. In another embodiment, call response program 37 receives the response from the user of calling device 40 in the form of VoIP. In an embodiment, the response call response program 37 receives is no response (i.e., the user of calling device 40 decides not to respond to the question call response program 37 sent to the user of calling device 40).

In step, 255, call response program 37 responds accordingly. In an embodiment, call response program 37 responds to the response of the user of calling device 40 based on the user preferences of the user of receiving device 30. For example, call response program 37 sends the user of calling device 40 straight to voicemail when the user of calling device 40 responds that the call is not urgent. In another example, when the user of calling device 40 responds that the call is not urgent, call response program 37 sends the user of calling device 40 straight to voicemail and sends a message to the user of calling device 40 that the user of receiving device 30 will contact the user of calling device 40 when the user of receiving device 30 is available. In yet another example, when the user of calling device 40 responds that the call is urgent, call response program 37 alerts the user of receiving device 30 that the user of receiving device 30 should answer the phone call.

Processing ends when the user of calling device 40 or the user of receiving device 30 terminates the call, or when the user of receiving device 30 answers the phone call, or when the voicemail answers the phone call.

In an example, on a Tuesday at 3:30 PM, call response program 37 receives an indication that Bill is calling Bob. Upon receiving the indication of the call, call response program 37 retrieves the user preferences that Bob predetermined. After call response program 37 retrieves the user preferences predetermined by Bob, call response program 37 determines that Bob predetermined automatic mode to be enabled on weekdays from 9 AM to 5 PM. Call response program 37 determines Bob wants call response program 37 to send, “Is this call urgent?” automatically to callers that call Bob on weekdays from 9 AM to 5 PM. Call response program 37 automatically sends Bill the question, “Is this call urgent?” Call response program 37 instructs Bill to “press one” for yes, if the call is urgent or “press two” for no, if the call is not urgent. Call response program 37 receives a response from Bill that the call is urgent. Call response program 37 displays the response to Bob on the screen of receiving device Bob received the call on. Call response program 37 displays the response on the screen of the receiving device in text form.

In another example, call response program 37 receives an indication that Jill is calling Jane. Jill has call response program 47 installed on the calling device that Jill is using to call Jane. Upon receiving an indication of the call, call response program 37 determines that Jane predetermined that manual mode is to be enabled when callers call the receiving device of Jane. Call response program 37 prompts Jane to select a question that call response program 37 should send to Jill from a list of questions Jane predetermined. Call response program 37 receives input from Jane to send Jill the question, “Can I call you back in five minutes?” Call response program 37, via call response program 47, receives the response of Jill in an audible form. Call response program 37 plays the audio response to Jane.

FIG. 3 depicts computer system 300, which is an example of a system that includes call response program 37. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage x05 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing additional context of a call from a caller, the method comprising:
receiving, by one or more computer processors, an indication of a call from a first device to a second device, wherein the indication includes making the call by a first user using the first device to a second user using the second device;
determining, by one or more computer processors, user preferences of the second user receiving the call using the second device, wherein the user preferences of the second user is all of the following: a predetermined instructions for how to respond to calls depending on the caller, a predetermined instructions for how to respond to calls depending on the context of the call, a predetermined instructions for how to respond to calls depending on a time of day the call is received, a predetermined instructions for how to respond to calls depending on a day of a week the call is received, and a predetermined instructions for how to respond to calls depending on a location of the second user when the call is received;
determining, by one or more computer processors, whether automatic mode is enabled based on the user preferences of the second user;
responsive to determining automatic mode is enabled, transmitting, by one or more computer processors, a first question to the first device, wherein the first question is determined from a predetermined one or more questions based on the user preferences of the second user;
determining, by one or more computer processors, whether manual mode is enabled based on the user preferences of the second user;
responsive to determining manual mode is enabled, prompting, by one or more computer processors, the second user to select a second question to send to the first device from a predetermined one or more questions based on the user preferences of the second user;
responsive to receiving an indication of a selection of the second question from the predetermined one or more questions, transmitting, by one or more computer processors, the second question to the first device;
receiving, by one or more computer processors, a response to either the first question or the second question from the first device, wherein the response is selected from the group consisting of a 1, 2, 3, or 4 dual-tone multi-frequency signaling (touch-tone), a text message, an audible message, no response, an automatic response, or a manual response; and
responsive to receiving a response to the first question or the second question from the first device, determining, by one or more computer processors, an action the second device will take based on the received response from the first device, wherein the action is selected from the group consisting of sending the call to voicemail, allowing the call to continue to ring, alerting the second user of the call to answers the call, and sending the second user a message.
